(19) United States
(12) Patent Application Publication
(10) Pub. No.: US 2022/0203857 A1
(43) Pub. Date: Jun. 30, 2022

(54) ACCELERATED ELECTRIC VEHICLE CHARGING WITH SUBCOOLED COOLANT BOILING

(71) Applicants: Ford Global Technologies, LLC, Dearborn, MI (US); Purdue Research Foundation, West Lafayette, IN (US)

(72) Inventors: Myung Ki Sung, Ypsilanti, MI (US); Michael W. Degner, Novi, MI (US); lssam Mudawar, West Lafayette, IN (US); Seunghyun Lee, Buk-gu Gwangju (SK); Devahdhanush Vijayaraju Swathibanu, West Lafayette, IN (US)

(21) Appl. No.: 17/138,325

(22) Filed: Dec. 30, 2020

(51) Int. Cl. B60L 53/60; B60L 53/18; B60L 53/302

(52) U.S. Cl. CPC B60L 53/60; B60L 53/302; B60L 53/18

(57) ABSTRACT

A charge system includes a charge cable containing a coolant to be circulated therethrough, and wires submersed and in direct contact with the coolant. The charge system also includes a controller that alters a pressure of the coolant within the charge cable to maintain nucleate boiling of the coolant.

### TECHNICAL FIELD

The present disclosure relates to charging technology that may be used in motor vehicle charging stations/equipment to facilitate accelerated charging.

### BACKGROUND

As interest in deployment of electric vehicles increases worldwide, there are fundamental obstacles that should be addressed. First, electric charging of vehicles may require deployment of a network of charging stations along highways and roads. Second, using present charging technology, charging times may be too long for the average consumer.

### SUMMARY

A charge station includes a charge cable defining a cavity therein that contains electrical conductors in a dielectric coolant that completely surrounds and is in direct contact with the electrical conductors, and a controller. The controller, responsive to data being indicative of a difference in a surface temperature of the electrical conductors and a saturation temperature of the dielectric coolant exceeding a critical heat flux threshold, increases a flow rate of the dielectric coolant through the charge cable to maintain nucleate boiling of the dielectric coolant in direct contact with the electrical conductors.

A method for controlling a charge station includes altering by a controller an inlet temperature of a coolant flowing through a cavity defined by a charge cable that contains electrical conductors, configured to convey charge, to maintain nucleate boiling of the coolant in direct contact with the electrical conductors as a surface temperature of the electrical conductors varies.

A charge system includes a charge cable containing a coolant that is circulated therethrough and wires submersed and in direct contact with the coolant. The charge system also includes a controller that alters a pressure of the coolant within the charge cable to maintain nucleate boiling of the coolant during transfer of charge via the wires as a surface temperature of the wires varies.

### BRIEF DESCRIPTION OF THE DRAWINGS

FIG. 1 is a bar chart showing heat transfer coefficients attainable with different coolants and cooling configurations.

FIG. 2 is a plot of wall heat flux versus surface superheat temperature.

FIG. 3 illustrates three states of boiling from FIG. 2.

FIG. 4 is a schematic diagram of a vehicle and charging station.

FIG. 5 is a schematic diagram of a closed flow loop cooling system.

FIG. 6 is a schematic diagram of a charging cable.

FIG. 7 is a plot of temperature versus time for a conductor wire at various axial locations, coolant, and ambient air.

FIG. 8 is a perspective view of a charging cable.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As used in the specification and the appended claims, the singular form “a,” “an,” and “the” comprise plural referents unless the context clearly indicates otherwise. For example, reference to a component in the singular is intended to comprise a plurality of components.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ±0%, 0.1%, 0.5%, 1%, 2%, 3%, 4%, 5% or 10% of the value or relative characteristic.

Charging times may be too long in part because conventional charge cables (“cables” or “ports” or “charging cables”) used to supply electrical current to vehicles cannot deliver large enough loads of electrical current, needed to speed up charging, without generating heat. In other words, charging time is inversely correlated with the amount of electrical current supplied to the vehicle. Accordingly, as the amount of electrical current supplied to the vehicle increases, the charging time decreases. The amount of electrical current supplied to the vehicle, however, is directly correlated to the amount of heat produced. The greater the amount of electrical current supplied to the vehicle, the greater the amount of heat produced. As such, a limitation to “ultra-fast charging” is excessive heat generation, due to demand for high electrical current transfer to lower the charging time.

Put another way, a concern associated with “fast charging” may be that passage of electrical current through any conductor results in a finite amount of heat generation, the higher the current load the greater the amount of heat generated. If the heat generated exceeds a specific amount, depending on the type of conductors used, conductors, which are typically comprised of a bundle of wires, may begin to melt (“burnout”). To compensate for this limitation and allow supply of a greater amount of electrical current, conductors with larger bundles of wires may be needed. Naturally, this larger bundle of wires substantially increases the size of the charging cable needed to transfer larger amounts of electrical current. Indeed, standards used to size conductor wires (“wire gauge”) in the industry are based on electrical current (typically in Ampere) needs while accounting for electrical insulating material used and heat dissipation requirements. For example, due to temperature limitations, a charging cable for conventional 350 Amperes “fast charging” systems requires substantial conductor size, rendering the charging cable quite heavy and inconvenient for customers to maneuver. Additionally, liquid coolant is conventionally used to remove heat from such a charging cable. The weight of this liquid coolant, in addition to a need for a large charging connector, exasperates this weight and maneuverability problem.

With present efforts in the automobile industry to transition to “ultra-fast charging,” a conductor's ability to deliver electrical current should be increased. For example, increasing the current from 350 to 1400 Amperes could reduce charging time for large commercial electric vehicles to an acceptable five-minute goal. Such higher current load, however, could increase the amount of heat generated by well over an order of magnitude, thereby requiring a substantial increase in conductor size and the amount of cooling liquid needed, which in turn would influence the feasibility of such a system due to the above-mentioned problems of weight and maneuverability.

This need for effective heat dissipation technology is not unique to the automotive industry. Developments in many modern technologies are becoming increasingly dependent on the ability to remove enormous amounts of heat from increasingly tighter space. This trend has been driven largely by fast advances in electronic and power devices found in computers, data centers, hybrid and electric vehicles, and both aerospace and defense applications. While pursuit of denser system architectures has resulted in significant performance improvements, it also precipitated steady increases in heat dissipation.

Over three decades ago, these challenges were met by use of a variety of fin attachments to the surface of the heat-generating part, which were cooled by either stagnant or forced airflow. But as heat generation densities continued to escalate, attention became focused more on liquid cooling schemes, which rely on the superior cooling properties of liquids compared to air. With further increases in heat generation density over time, however, even liquid schemes began to fall short of maintaining acceptable system temperatures. This forced designers in recent years to transition from cooling systems utilizing pure liquids to those that rely on liquid-to-vapor phase change (boiling). Liquid-to-vapor phase change relies on boiling of the coolant on the surface being cooled and occurs after the surface temperature exceeds the fluid's boiling point. High heat fluxes may be achieved using the phase change, making this phenomenon valuable where large amounts of heat are needed to be transferred from a relatively small space.

The primary difference between the pure liquid cooling scheme and the liquid-to-vapor phase change cooling scheme is as follows. With pure liquid cooling, the coolant captures the heat and incurs a temperature rise (commonly referred to as “sensible heating”). The coolant is then routed to a remote heat exchanger, where the heat is rejected, bringing liquid temperature back to initial value in order to begin a new cooling cycle. But, with liquid-to-vapor phase change cooling schemes, a coolant, initially in liquid state, captures the heat by capitalizing mostly on the energy required per unit mass to convert liquid to the vapor phase (commonly referred to as “latent heat of vaporization”) in addition to its sensible heat. This allows liquid-to-vapor phase change schemes to remove comparatively lager amounts of heat while maintaining lower system temperatures.

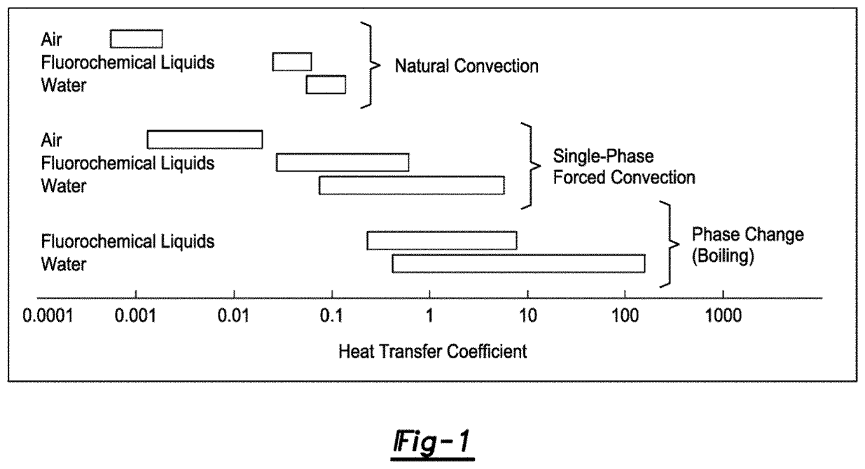

FIG. 1 shows differences in cooling effectiveness among air cooling, pure liquid cooling, and liquid-to-vapor phase change cooling schemes. The effectiveness measure shown is heat transfer coefficient, which is the rate of heat removal divided by product of heat dissipation area and surface-to-coolant temperature difference. FIG. 1 further demonstrates that effectiveness is dictated by both cooling configuration and type of coolant used.

Three cooling configurations are shown: 1) natural convection where mild coolant motion is achieved by temperature-induced density gradients; 2) forced convection where coolant motion is achieved by a mechanical source such as a fan or pump; and 3) phase change. FIG. 1 further demonstrates superiority of phase change to both forced convection and natural convection.

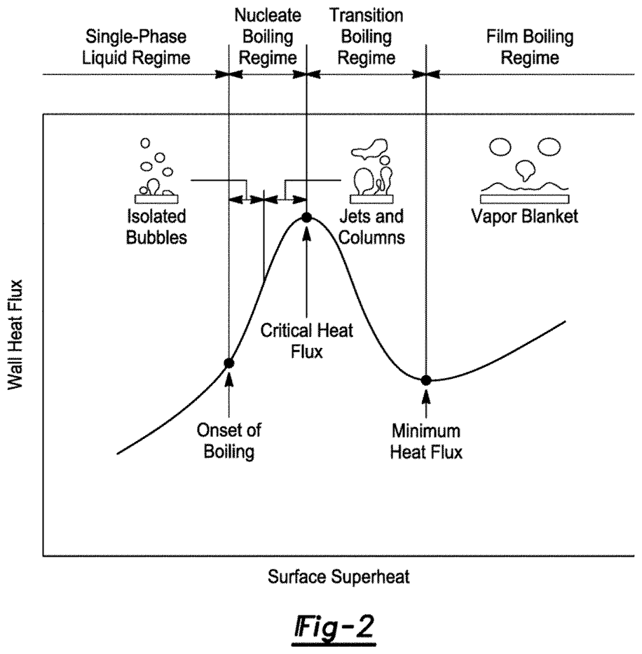

FIG. 2 displays a boiling curve representing variation of heat flux versus surface superheat. Heat flux is defined as heat rate divided by surface area, and surface superheat is defined as heated surface temperature minus boiling point (or saturated liquid temperature). FIG. 2 further shows different boiling regimes and transition points between regimes encountered with increasing heat flux. The boiling curve shown is comprised of four regimes: (1) single-phase liquid regime, corresponding to only low heat fluxes, (2) nucleate boiling regime, associated with nucleation (formation) of bubbles at and departure from the surface, (3) transition boiling regime, where portions of the surface encounter bubble nucleation while other regions are blanketed with vapor, and (4) film boiling regime, corresponding to high surface temperatures that cause vapor blanketing over the entire surface. The nucleate boiling regime is thus between the onset of boiling and the critical heat flux. For a given coolant, the temperature at which the onset of boiling occurs is usually known in advance. It, for example, may be defined by the manufacturer for a given pressure, etc. The temperature at which critical heat flux is achieved can be determined in advance via testing or simulation as it corresponds to the surface superheat temperature at which the wall heat flux achieves a first maximum after the onset of boiling.

These four regimes are demarcated by three transition points: (i) onset of boiling, corresponding to first bubble formation on the surface, (ii) critical heat flux, where bubble nucleation in nucleate boiling is replaced by localized vapor blankets merging together across the surface, and (iii) minimum heat flux, corresponding to the onset of breakup of the continuous vapor blanket as wall heat flux is decreased from film boiling. These transition points mark changes in heat transfer effectiveness between the regimes, with the nucleate boiling regime providing the highest heat transfer coefficients and the film boiling regime the lowest.

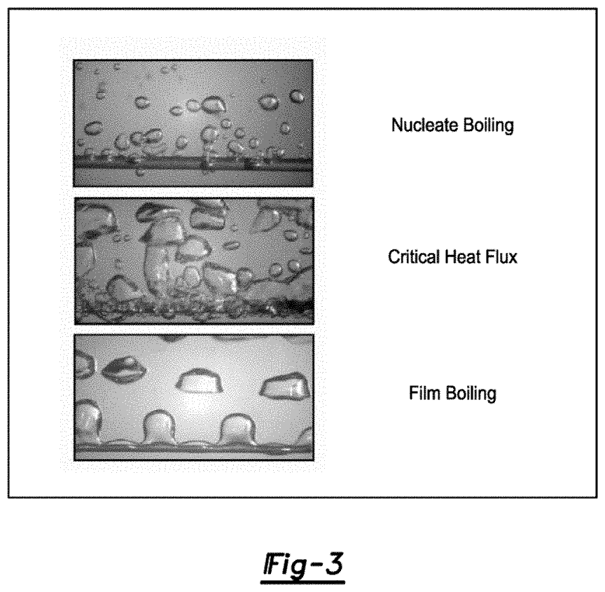

FIG. 3 exemplifies the drastic differences in cooling behavior between boiling curve regimes for boiling on a current carrying wire submerged in a pool of liquid coolant. In the nucleate boiling regime, the upper image in FIG. 3, vapor bubbles form, grow, and depart from the surface, drawing bulk liquid towards the surface at high frequency which, along with the ensuing latent and sensible heat exchange, greatly increases cooling effectiveness, allowing for dissipation of a broad range of heat fluxes corresponding to only modest increases in surface temperature. For cooling effectiveness within this regime to be maintained, the vapor-liquid exchange process requires uninterrupted liquid access to the surface. Increased bubble coverage of the surface, however, will eventually lead to significant coalescence between bubbles and begins restricting liquid access to the surface. Once the vapor-liquid exchange process is interrupted, the heat will no longer be rejected, and surface temperature begins to escalate uncontrollably. This condition, which is depicted in the middle image in FIG. 3, is the upper-most heat flux limit for the nucleate boiling regime corresponding to critical heat flux.

The lower image in FIG. 3 shows conditions within the film boiling regime corresponding to very high surface temperatures that are reached beyond critical heat flux occurrence. Under these circumstances, the surface in film boiling is completely isolated from liquid by a continuous vapor blanket. Heat is transferred to the liquid by conduction across this virtually insulating vapor blanket, as well as by radiation. The poor heat transfer coefficient associated with the combined conduction/radiation explains the high surface temperatures corresponding to film boiling.

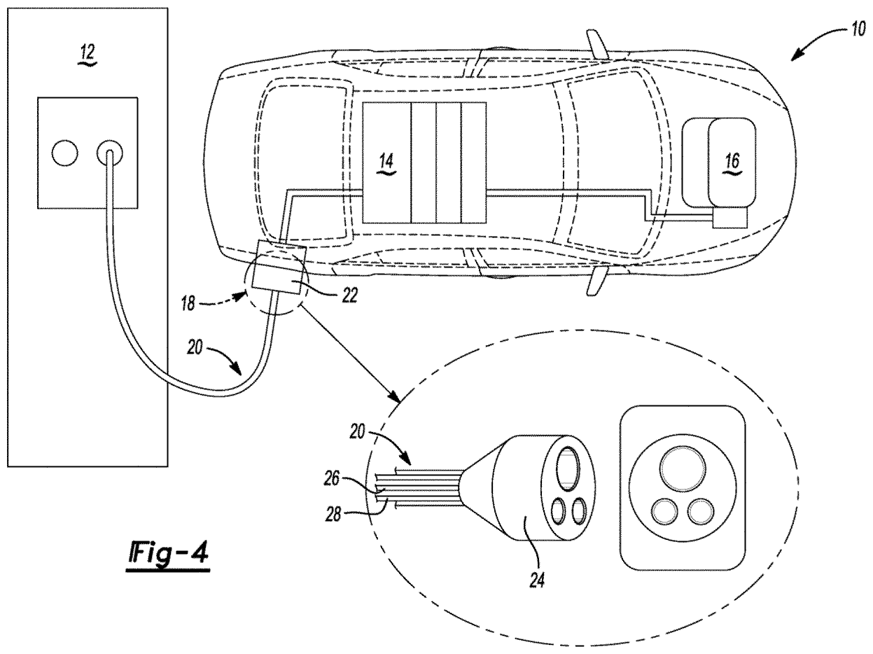

FIG. 4 demonstrates the above-referenced problem associated with “fast-charging.” While this figure depicts a vehicle charging station, neither the problems associated with “fast-charging,” nor the disclosed solution are limited to vehicle charging stations. In particular, FIG. 4 illustrates a vehicle 10 coupled to a charging station 12. The vehicle 10 is comprised of battery 14, electric motor 16, and a charging inlet 18. The charging station 12 is comprised of a charging cable 20 and a plug 22. The plug 22 is further comprised of charging connector 24. The charging cable 20 is further comprised of a bundle of wires 26.

During charging, the charging cable 20, through the bundle of wires 26 and charging connector 24, may be coupled with the vehicle charging inlet 18. Electrical current may then be supplied from the charging station 12 to the vehicle 10. This electrical current may then be delivered to the internal battery 14 of the vehicle 10, which in turn may be used to power the electric motor 16. Passage of electrical current through the bundle of wires 26 results in a finite amount of heat generation, the higher the electrical current load the greater the amount of heat generated. To facilitate supply of a greater amount of electrical current, larger bundles of wire may be needed. This increase in size results in an increase in size of the charging cable 20 which houses the bundle of wires 26.

This increase in size may also render the charging cable 20 quite heavy and inconvenient for customers to maneuver for coupling to the vehicle 10. Furthermore, to remove heat from the bundle of wires 26, conventionally, liquid coolant may be passed through a conduit 28 housed within the charging cable 20.

To resolve these potential issues, a two-phase cooling system is proposed. More particularly, this two-phase cooling system may be applied to an electric charging station to facilitate accelerated charging. In one or more embodiments, this two-phase cooling system is applied to vehicle electric charging stations to accelerate charging by removing a greater amount of heat that is inevitably generated in delivering more electrical current.

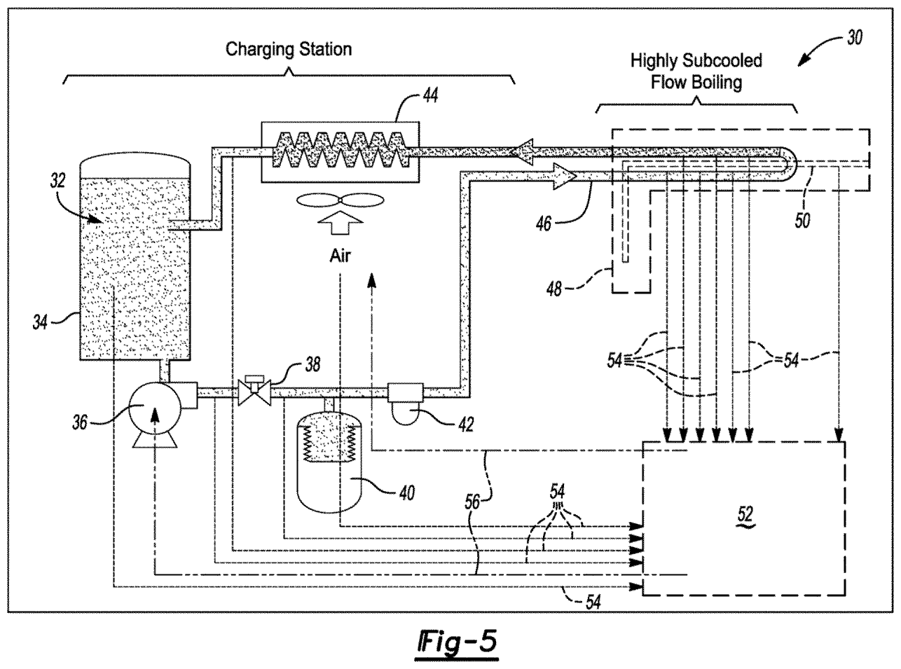

FIG. 5 illustrates an exemplary schematic of a closed flow loop cooling system. Closed flow loop as disclosed here refers to a coolant delivery system which is sealed from ambient air. In the embodiment shown, a closed flow loop cooling system 30, which utilizes a dielectric (non-electrically conducting) coolant 32, is applied to a vehicle charging station. In this embodiment, the closed flow loop cooling system 30 may comprise a coolant reservoir 34, pump 36, flow controller 38, accumulator 40, filter 42, and heat exchanger 44. The coolant 32 may be sent from the coolant reservoir 34 to the flow controller 38 using the pump 36. The flow controller 38 may then regulate both flow rate and pressure of the coolant 32. The coolant 32 may then be sent to the accumulator 40 which could serve to compensate for changes in the coolant 32 volume due to vapor formation in the liquid and/or help reduce pressure oscillations. The coolant 32 may then flow to the filter 42 to remove any particulates or impurities before proceeding to conductor charging cable 48.

Subsequently, the coolant 32 may flow through a conduit 46 housed within charging cable 48 to capture the heat generated due to the passage of electrical current through electric conductor wire 50. In one embodiment, the coolant 32 may capture heat from the electric conductor wire 50 by partially changing phase into vapor creating a liquid-vapor mixture. This liquid-vapor mixture may then be returned to the heat exchanger 44 which converts the vapor back into its liquid state by rejecting the heat to ambient air. The coolant 32 may then be returned to the reservoir 34 at a temperature substantially similar to its initial temperature.

The block diagram (or schematic) shown in FIG. 5 is merely an exemplary embodiment of equipment and their arrangement. This disclosure is not limited to this specific embodiment as specific components and/or conditions may, of course, vary. For example, in some embodiments, multiple pumps may be used to maintain the coolant's flow rate and pressure throughout the loop such that the coolant remains in the nucleate boiling regime, but below the critical heat flux. In other embodiments, one or more pumps may be needed in addition to one or more pressure regulators to maintain the coolant's flow rate and pressure throughout the loop such that the coolant remains in the nucleate boiling regime, but below the critical heat flux to facilitate optimum heat removal of the electric conductor wire. To maintain the coolant in the nucleate boiling regime, the temperature of the electrical conductor wire must be high enough to be accompanied by the formation of vapor bubbles on its surface which may break of, rise, and condense before or at the free coolant surface. To maintain the coolant below the critical heat flux, still higher temperatures of electrical conductor wires should be avoided as at such still higher temperatures a vapor film may form around the electrical conductor wires which may act as a considerable resistance to heat transfer.

In one or more embodiments a controller (or processor) 52 may be used to gather inputs, such as temperature, pressure, and flow rate from the coolant 32, from standard sensors 54 (e.g., temperature sensors, pressure sensors, flow rate sensors, etc.). For a given coolant (e.g., a dielectric coolant), the controller 52 may receive input signals regarding a variety of parameters. In some embodiments, the controller receives input signals regarding the coolant's temperature, flow rate, and pressure at various points along the loop. In some embodiments, the controller 52 also receives input signals from the standard sensors 54 regarding the surface temperature of the heat emitting conductor 50. The controller 52 may then compare these measurements with a set of specific predetermined values (obtained via testing, simulation, etc.) and actively alter operating parameters to maintain the coolant's temperature and pressure throughout the loop, such that when in direct contact with the conductors 50, the coolant 32 remains in the nucleate boiling regime and below the critical heat flux. For example, for a given coolant, the controller 52 may evaluate the difference between the surface temperature of the electrical conductors 50 and a saturation temperature of the coolant 32 (hereinafter “surface superheat”) in the charging cable 48 and increase or decrease flow rate to maintain the coolant 32 in the nucleate boiling regime.

In one embodiment, in response to inputs from the standard sensors 54, the controller 52 actively alters the coolant's flow rate by sending a signal 56 to one or more pumps situated along the loop. In another embodiment, in response to inputs from the standard sensors 54, the controller 52 actively alters the coolant's flow rate by sending a signal 56 to one or more pressure regulators situated along the loop. In yet another embodiment, in response to inputs from the standard sensors 54, the controller 52 uses both pumps and pressure regulators to assure that the coolant 32 in direct contact with the heated surface of the conductors 50 remains in the nucleate boiling regime. Similarly, in some embodiments, in response to inputs from standard sensors 54, the controller 52 actively alters the air flow rate intake of the heat exchanger 44 by sending a signal 56 to one or more blowers (e.g., centrifugal fan) used in conjunction with the heat exchanger 44. As mentioned above, FIG. 5 is merely an exemplary embodiment. It is to be understood that the nature of input and output signals, received, processed, and sent by the controller 52 may vary based on the position of the standard sensors along the loop and the types of equipment used. For example, in an embodiment that uses a shell and tube exchanger instead of the depicted heat exchanger, the input signal 56 may relate to the flow rate of a liquid used to lower the coolant's 32 temperature.

In one embodiment, the controller utilizes a feedback loop. Lookup tables may be used to maintain the coolant temperature in the nucleate boiling regime. For example, the controller may receive the coolant and the heat-emitting surface temperature measurement signals from one or more temperature sensors situated along the loop. The controller may then compute the surface superheat by evaluating the temperature difference between the two. The controller may then compare the surface superheat with the prestored values for onset of boiling and critical heat flux to assure that this value remains in the acceptable range to maximize heat flux. If the surface superheat temperature exceeds a certain value (identified via testing, simulation, etc.), the controller may increase the flow rate using pumps and/or pressure regulators. If, however, the surface superheat temperature falls below a certain value (identified via testing, simulation, etc.), the controller may decrease the flow rate using pumps and/or pressure regulators. In another embodiment, the controller may increase or decrease the air flow to the heat exchanger to remove more or less heat based on a desired coolant's inlet temperature.

In one embodiment, the controller 52 may be programmed to, such that in response to data being indicative of a difference in a surface temperature of the electrical conductors 50 and a saturation temperature of the coolant 32 exceeding a critical heat flux threshold, increase a flow rate of the coolant 32 through the charge cable 48 to maintain nucleate boiling of the coolant 32 in direct contact with the electrical conductors 50. The controller 52 may be further programmed to, such that in response to data being indicative of the difference in a surface temperature of the electrical conductors 50 and a saturation temperature of the coolant 32 being less than a boiling threshold, decrease the flow rate to initiate nucleate boiling of the coolant 32.

Similarly, the controller 52 may be further programmed to, such that in response to data being indicative of the difference in a surface temperature of the electrical conductors 50 and a saturation temperature of the coolant 32 exceeding the critical heat flux threshold, decrease an inlet temperature of the coolant 32. In yet another embodiment, the controller 52 may be further programmed to, such that in response to data being indicative of the difference in a surface temperature of the electrical conductors 50 and a saturation temperature of the coolant 32 being less than a boiling threshold, increase an inlet temperature of the coolant 32.

The controller 52 may also be programmed to, such that in response to data being indicative of the difference in a surface temperature of the electrical conductors 50 and a saturation temperature of the coolant 32 exceeding the critical heat flux threshold, decrease a pressure of the coolant 32. And, the controller 52 may be further programmed to, such that in response to data being indicative of the difference in a surface temperature of the electrical conductors 50 and a saturation temperature of the coolant 32 being less than a boiling threshold, increase the pressure of the coolant 32.

The coolant 32 may be configured to be circulated through the charge cable 48 in direct contact with electrical conductor wires 50 such that electrical conductor wires 50 may be partially or fully submersed in the coolant 32. The controller 52 may be programmed to alter a pressure of the coolant 32 within the charge cable 48 to maintain nucleate boiling of the coolant 32 during transfer of charge via the wires 50 as a surface temperature of the wires 50 varies. In one embodiment, the controller 52 may, in response to data being indicative of a difference in a surface temperature of the wires 50 and a saturation temperature of the coolant 32 exceeding a critical heat flux threshold, decrease the pressure of the coolant 32. The controller 52 may also, in response to data being indicative of a difference in a surface temperature of the wires 50 and a saturation temperature of the coolant 32 being less than a boiling threshold, increase the pressure of the coolant 32.

In one or more embodiments, the arrangement of the equipment discussed in connection with FIG. 5 may be different. For example, in one embodiment, the accumulator 40 may be placed in the coolant return line after removal of heat from the electric charging conductor wire 50. In other embodiments, the equipment types may vary. For example, in one embodiment the heat exchanger used to convert the vapor back into its liquid state may be a condenser. In another embodiment, the heat exchanger used along the coolant return line may be a shell and tube exchanger. Indeed, to maximize efficiency, the heat captured from the electric conductor wire may be used for different applications. For example, in one embodiment the heat captured may be used to operate a thermodynamic cycle for electrical energy generation. In another embodiment, the heat generated may be used to supply a heating station.

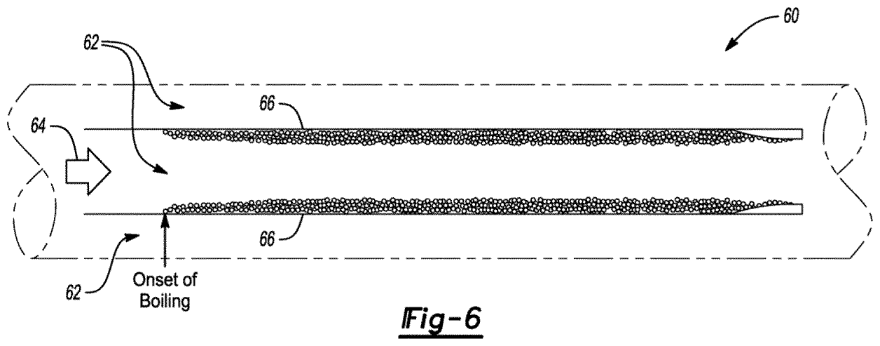

FIG. 6 is a closeup of a charging cable 60 defining a cavity 62 to facilitate the flow of a coolant 64. The coolant 64 may flow in direct contact with electric conductor wires 66 to remove the heat generated due to passage of electrical current. This figure demonstrates the state of the coolant 64 as it captures heat from the electric conductor wires 66. More specifically, this figure depicts how a liquid-to-vapor phase change cooling scheme may be used to capture the heat generated by the passage of electrical current through the conductor wire. In such a scheme, the coolant, initially in a liquid state may remove heat via both latent heat of vaporization as well as sensible heat. The combination of these two mechanisms allows liquid-to-vapor phase change schemes to remove comparatively lager amounts of heat while maintaining lower system temperatures.

In one or more embodiments, coolant may be introduced into the charging cable at a temperature below the coolant's boiling point. In general, a liquid at a temperature below its normal boiling point is referred to as subcooled. Similarly, a liquid at a temperature far below its normal boiling point may be referred to as highly subcooled. In one or more embodiments, the coolant introduced to the charging cable may be at a temperature far below the coolant's boiling point (i.e., highly subcooled). For example, a highly subcooled liquid may have a range of temperatures at an inlet to the system between 15 degrees Celsius below the saturation/boiling temperature and 15 degrees Celsius above the freezing temperature, between 10 degrees Celsius below the saturation/boiling temperature and 10 degrees Celsius above the freezing temperature, or between 5 degrees Celsius below the saturation/boiling temperature and 5 degrees Celsius above the freezing temperature. The highly subcooled coolant temperatures can be determined/controlled by parameters such as charging current, coolant flow rate, cable conductor temperature, and coolant conduit pressure to maintain the nucleate regime.

Introduction of highly subcooled coolant into the charging wire and maintaining nucleate boiling temperatures when in contact with conductor wires has several advantages. First, it may allow for very high heat flux removal from the conductor wires while maintaining low wire temperatures. In one or more embodiments, this heat flux removal may be several orders of magnitude better than pure liquid cooling. Second, it may ameliorate a critical heat flux value, thereby guarding against burnout when dissipating high current. Third, despite the formation of vapor in the charging cable, because of the highly subcooled state, the coolant maintains a mostly liquid state, which greatly simplifies coolant flow and handling along the loop compared to a coolant introduced at temperature close to the boiling point.

The heat removal efficiency of this system is particularly advantageous for applications with demand for a large load of electrical current delivery over a short period of time. Since electrical current flow is directly correlated to heat generation and the above-mentioned system is highly efficient in heat removal, charging cables with ability to transfer larger electrical current load may be adopted to facilitate faster charging. More specifically, this newly found heat removal efficiency may reduce the need for large quantities of coolant, thereby reducing the charging cable's size. This reduction in size may greatly reduce the weight of charging cables and enhance their maneuverability.

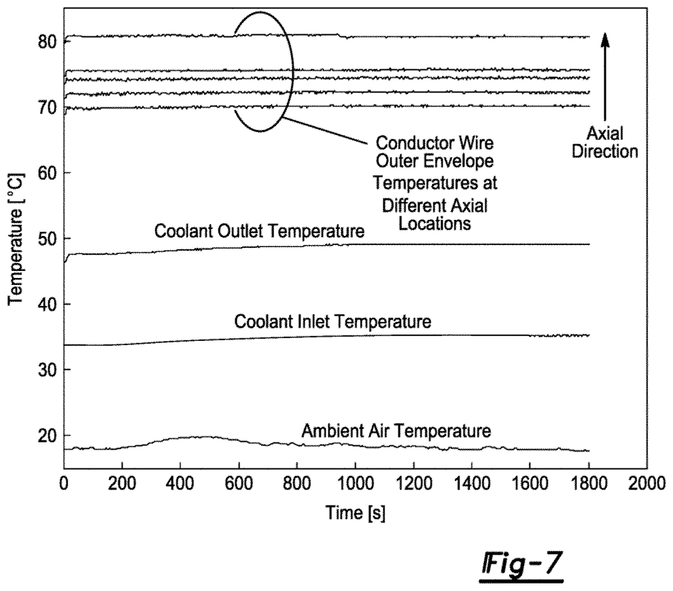

FIG. 7 depicts the effectiveness of a subcooled boiling system. In particular, FIG. 7 shows the heat removal effectiveness of a subcooled boiling system from a wire carrying 1944 Amperes using a dielectric coolant (e.g., HFE-7100) flow rate of 0.71 gallons per minute. This, and other appropriate dielectric coolants, have low contact angles (are wettable) between the cable conductor/wire and coolant itself. Low contact angle means less than a 90 degree angle. A low contact angle allows the coolant to penetrate deep within intricate spaces between any fin attachment hubs (discussed below) and conductor wires, thereby enhancing heat removal. This is fundamentally different from standard fins, which require absence of any contact between conductor and coolant.

FIG. 7 further shows the temporal record of conductor wire temperature at different axial locations. This figure depicts a coolant's inlet temperature of 34 degrees Centigrade which is well below the boiling point of this coolant (64 degrees Centigrade), with electrical conductor wires carrying 1944 Amperes.

Depending on the application needs, heat removal efficiency of the subcooled boiling system may still be improved using fins. Given that heat flux is defined per unit area, significant improvements may be possible with the use of fin attachments to the exterior of the conductor wires. Simply put, attachment of tins intermittently to the exterior of the conductor wires increases the outer surface area of wires in contact with the coolant, allowing much larger amounts of heat to be removed and thereby much higher current (above the 1944 Amperes indicated in FIG. 7) for a given coolant flow rate, or alternatively, enables use of smaller wire diameter (therefore a lighter cable) for a given electrical current.

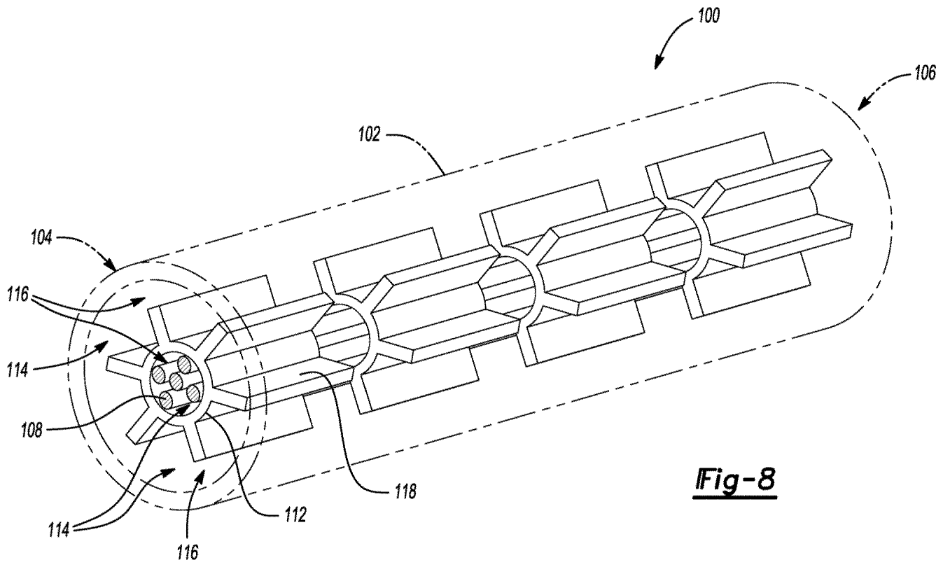

FIG. 8 displays a charging cable 100 comprising an insulating shell 102 having a first end 104 and a second end 106. The charging cable 100 may further comprise conductor wires 108. In some embodiments, the conductor wires 108 may be merely collected together. For ease of reference, this collection of wires together is referenced as an outer envelope. In one or more embodiments, the conductor wires 108 may be collected together within a housing 112. While both the charging cable 100 and outer envelope/housing 112 may take any shape, they are generally substantially circular such that the diameter of insulating shell Ds is larger than the diameter of outer envelope Do or the diameter of housing Dh. This difference in diameter creates a cooling conduit (or “cavity”) 114 which facilitates the flow of coolant 116. The coolant 116 travels past the outer envelope 110 or the housing 112, reducing its temperature. In one embodiment, the coolant 116 may flow in a void area defined by the collection of conductor wires 108 together.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

In some embodiments, the outer envelope 110 may be suspended in the coolant 116 within the insulating shell 102. In one embodiment, the outer envelope 110 may be situated substantially central to the insulating shell 102. Similarly, in some embodiments, the housing 112 may be suspended in the coolant 116 within the insulating shell 102. In one embodiment, the housing 112 may be situated substantially central to the insulating shell 102.

In some embodiments, the fins 118 are attached to an exterior surface of the wires 108 (for ease of reference outer envelope). In one embodiment, the fins 118 are crimped around the wires 108. In other embodiments, multiple fins 118 are attached to the exterior surface of the housing 112. The fins 118 increase the surface area in contact with the coolant 116 and thereby allow removal of a larger amount of heat. As the size/number of the fins 118 increase, the surface area increases permitting removal of more heat. Accordingly, the number of fins 118 and the size of such fins 118 depends on the amount of heat that needs to be removed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

While FIG. 8 shows an embodiment of this disclosure that comprises the fins 118. This disclosure is not limited to such an embodiment. Depending on the heat removal needs, the charging cable 100 may not comprise the fins 118. Similarly, while FIG. 8 illustrates an embodiment of this disclosure that comprises the housing 112. This disclosure is not limited to such an embodiment. Rather, depending on the heat removal needs, instead of the housing 112, the conductor wires 108 may be merely collected together defining an outer envelope as mentioned above. In some embodiments, the coolant 116 may flow past either the outer envelope or the housing 112 across the length of the charging cable 100 reducing its temperature. Tw may denote the outer envelope or the housing 112 temperature, while Tf may denote the coolant temperature. Tw is larger than Tf defining the temperature gradient in the radial direction.

Methods for controlling a charge station may comprise altering by a controller an inlet temperature of a coolant flowing through a cavity defined by a charge cable that contains electrical conductors, configured to convey charge, to maintain nucleate boiling of the coolant in direct contact with the electrical conductors. In some embodiments, the method of controlling the charge station may decrease the inlet temperature of the coolant responsive to data being indicative of a difference in a surface temperature of the electrical conductors and a saturation temperature of the coolant exceeding a critical heat flux threshold. In other embodiments, the method of controlling the charge station may increase the inlet temperature responsive to data being indicative of a difference in a surface temperature of the electrical conductors and a saturation temperature of the coolant being less than a boiling threshold.

Methods for controlling a charge station may also comprise altering by a controller a flowrate of a coolant to maintain nucleate boiling of the coolant. In one embodiment, the method for controlling the charge station may further comprise altering by the controller a pressure of the coolant to maintain nucleate boiling of the coolant.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as Read Only Memory (ROM) devices and information alterably stored on writeable storage media such as floppy disks, magnetic tapes, Compact Discs (CDs), Random Access Memory (RAM) devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure.

As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A charge station comprising:
a charge cable defining a cavity therein that contains electrical conductors in a dielectric coolant that completely surrounds and is in direct contact with the electrical conductors; and
a controller programmed to, responsive to data being indicative of a difference in a surface temperature of the electrical conductors and a saturation temperature of the dielectric coolant exceeding a critical heat flux threshold, increase a flow rate of the dielectric coolant through the charge cable to maintain nucleate boiling of the dielectric coolant in direct contact with the electrical conductors.

2. The charge station of claim 1, wherein the controller is further programmed to, responsive to the data being indicative of the difference being less than a boiling threshold, decrease the flow rate to initiate nucleate boiling of the dielectric coolant.

3. The charge station of claim 1, wherein the controller is further programmed to, responsive to the data being indicative of the difference exceeding the critical heat flux threshold, decrease an inlet temperature of the dielectric coolant.

4. The charge station of claim 3, wherein the inlet temperature is between 5 degrees Celsius below the saturation temperature and 5 degrees Celsius above a freezing temperature of the dielectric coolant.

5. The charge station of claim 4, wherein the inlet temperature is between 10 degrees Celsius below the saturation temperature and 10 degrees Celsius above the freezing temperature.

6. The charge station of claim 5, wherein the inlet temperature is between 15 degrees Celsius below the saturation temperature and 15 degrees Celsius above the freezing temperature.

7. The charge station of claim 1, wherein the controller is further programmed to, responsive to the data being indicative of the difference being less than a boiling threshold, increase an inlet temperature of the dielectric coolant.

8. The charge station of claim 1, wherein the controller is further programmed to, responsive to the data being indicative of the difference exceeding the critical heat flux threshold, decrease a pressure of the dielectric coolant.

9. The charge station of claim 1, wherein the controller is further programmed to, responsive to the data being indicative of the difference being less than a boiling threshold, increase a pressure of the dielectric coolant.

10. The charge station of claim 1, wherein the electrical conductors include fins intermittently disposed thereon.

11. A method for controlling a charge station comprising:
altering by a controller an inlet temperature of a coolant flowing through a cavity defined by a charge cable that contains electrical conductors, configured to convey charge, to maintain nucleate boiling of the coolant in direct contact with the electrical conductors as a surface temperature of the electrical conductors varies.

12. The method of claim 11, wherein the altering includes decreasing the inlet temperature responsive to data being indicative of a difference in the surface temperature and a saturation temperature of the coolant exceeding a critical heat flux threshold.

13. The method of claim 11, wherein the altering includes increasing the inlet temperature responsive to data being indicative of a difference in the surface temperature and a saturation temperature of the coolant being less than a boiling threshold.

14. The method of claim 11 further comprising altering by the controller a flowrate of the coolant to maintain the nucleate boiling as the surface temperature varies.

15. The method of claim 11 further comprising altering by the controller a pressure of the coolant to maintain the nucleate boiling as the surface temperature varies.

16. A charge system comprising:
a charge cable containing a coolant configured to be circulated therethrough and wires submersed and in direct contact with the coolant; and
a controller programmed to alter a pressure of the coolant within the charge cable to maintain nucleate boiling of the coolant during transfer of charge via the wires as a surface temperature of the wires varies.

17. The charge system of claim 16, wherein the altering includes decreasing the pressure responsive to data being indicative of a difference in the surface temperature and a saturation temperature of the coolant exceeding a critical heat flux threshold.

18. The charge system of claim 16, wherein the altering includes increasing the pressure responsive to data indicative of a difference in the surface temperature and a saturation temperature of the coolant being less than a boiling threshold.

19. The charge station of claim 16, wherein the wires include fins intermittently disposed thereon.

20. The charge station of claim 16, wherein the coolant is a dielectric coolant.
